(19) United States
(12) Patent Application Publication
(10) Pub. No.: US 2004/0125216 A1
(43) Pub. Date: Jul. 1, 2004

(54) Context based tagging used for location based services

(76) Inventors: Dhananjay V. Keskar, Beaverton, OR (US); Mic Bowman, Beaverton, OR (US)

Correspondence Address: FISH & RICHARDSON, PC, 12390 EL CAMINO REAL, SAN DIEGO, CA, 92130-2081, US

(21) Appl. No.: 10/335,146

(22) Filed: Dec. 31, 2002

(51) Int. Cl. H04N 5/232; H04N 5/76

(52) U.S. Cl. 348/231.2; 348/211.2; 348/211.3

(57) ABSTRACT

A system that the tracks a likely object within the user's field of view. This is done by taking a picture of the field of view, and processing that picture to determine likely objects within the picture being viewed. Those likely objects are than correlated against a database, and information about the objects are returned. The information can be either raw information that is sent over an information link, or an address to local information. The information sent back can indicate, for example, more information about a painting being viewed, or more information about a theme park attraction.

### BACKGROUND

There are many applications for location sensing. For example, satellite positioning systems such as the global positioning system or “GPS” may be used to pinpoint a user's current location. This may be used for navigation, or for an emergency situation.

### BRIEF DESCRIPTION OF THE DRAWINGS

These and other aspects will now be described in detail with reference to the accompanying drawings, wherein:

FIG. 1 shows a basic block diagram of a hand-held computer which may determine points in an area;

FIG. 2 shows a flowchart of operation; and

FIG. 3 shows a more detailed block diagram of the communication between computers which is automatically carried out.

### DETAILED DESCRIPTION

An environmental location system as described herein may provide a user with information that is based on the user's current location and field of view. This system may be used to provide location and context-sensitive information to a user who is located in an unfamiliar area such as an art museum or theme park, but may desire to know more information about the surroundings.

For example, in an art museum, a user may be viewing an exhibition room with several different objects. It may be useful to detect the specific painting or art item that the user is viewing. This could enable providing context-sensitive information.

Similarly, in theme parks, information about specified attractions may be tailored to an attraction or landmark being viewed by a user.

In an embodiment as described herein, a hand held computer determines a likely object or “artifact” which is being viewed by a user. The artifacts may include art objects, signs, lights and luminaries of many different types, or any landmark or other object. Location and artifact-sensitive information is provided to the user, based on the recognized artifact.

The information that is returned to a user is specific to the artifact. It may be an index to information that is locally stored, For example, the index may be a track number representing contents of a specified track on a locally-held information storage device such as a CD or hard drive. Alternatively, the descriptive information about the artifact may be stored on a central network server. In this case, actual information is returned from the server to the user.

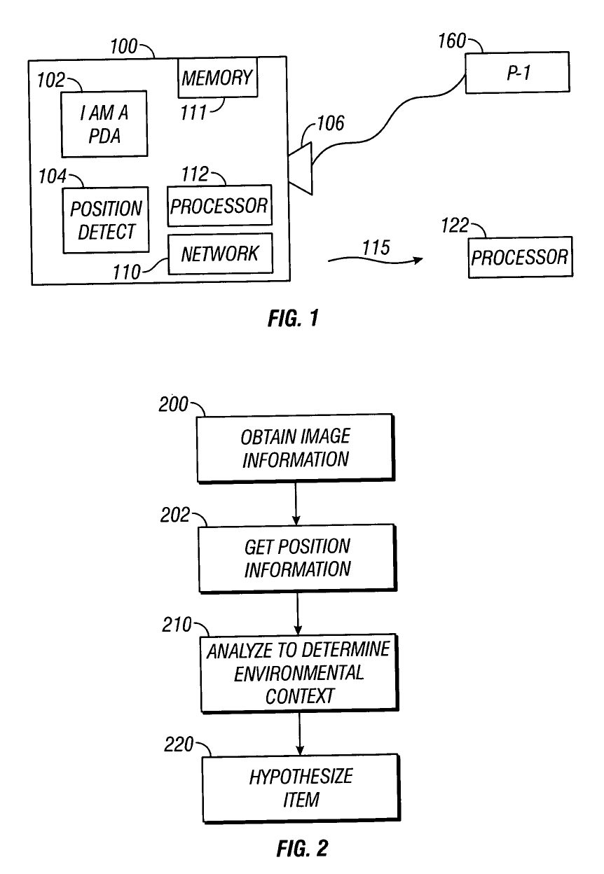

A basic block diagram of the embodiment is shown in FIG. 1. A hand-held device 100 is shown as being a personal digital assistant (“PDA”). The PDA includes a display 102 and also may optionally include certain peripheral devices including a location detecting device 104 such as a GPS or triangulation device, a camera 106, and a network connection device 110. The PDA also includes a processor, e.g. a portable processor or some other processor. The network device 110 is preferably a wireless networking device such as Bluetooth, 802.11, or the like which communicates with the network 120 via wireless communications shown as 115. The PDA may also include a storage part 111 which may include a removable static memory such as a memory stick, SD media, or other static memory, or may include a mass storage device such as a miniature hard drive or a CD. Many of these devices are conventionally included as part of PDA devices.

The use of the automatic position detecting system 104 may be optional. As described herein, an important feature is that this system may deduce its location from the field of view that is captured by the camera 106. This may be done by correlating the obtained image against a number of different image samples, each of which represents different likely locations of the user.

The camera 106 is arranged to point generally in a similar direction to a user's field of view. For example, the camera 106 may point to an object, here shown as painting 160. However, the camera 106 will image not only the painting 160, but also other, less “salient” items within the camera's field of view. The saliency analysis is based on postulated knowledge of the way the brain works. It is believed that the mammalian visual system uses a strategy of identifying interesting parts of the image without analyzing the content of the image. The mammalian visual system operates based on image information which may include brightness, motion, color and others.

The information from camera is processed by a processor which may be the local processor 112 within the PDA, or may be a network processor 122 within the network.

It is well known to process an image of the scene to determine contents of the scene and salience of different objects within the scene. For example, such image processing to determine salience may be done as known in the art. According to this system, a map or other type database may be formed which expresses the saliency of all locations in the image. The map analyzes the image in the same way that it is believed the human brain would so analyze the image, looking for image features including color, orientation, texture, motion, depth and others. The saliency analysis computes a quantity representing the saliency of each location in the field. In one embodiment, this filtering to multiple spatial scales may be carried out using Gaussian Filters. Each portion of the image is then analyzed by determining center-surround differences, both for intensity contrast and for colors. Orientation contrast may also be used. A difference of Gaussians may then be used to determine the saliency, using the center-surround differences, and the way that the center surround technique is formed. Other techniques of determining salience are also known, however.

This technique, and other similar techniques, correlate over the image of interest to determine artifacts within the image of interest. These are effectively distinguishing features. According to the present system, the processing element, which may be the local processor 112 or the network processor 122, analyzes the data, determines the likely field of view of the user, and identifies a most likely primary object of interest within that field of view. The system then returns information indicative of this object to the user's hand-held device.

The overall operation of the system is described with reference to the flowchart of FIG. 2.

At 200, the system obtains image information from the camera. The system gets position information at 202. This position information may be e.g. from the location detecting device 104. If the location device 104 is not provided, then the system may deduce its position information by correlating the image information obtained at 200 with a number of templates representing different images at different known locations within the known area. For example, in the context of an art museum, the memory may store associated images indicative of a number of the different paintings and rooms, each from multiple different angles. The viewed item may be determined by correlating different image samples across the different templates, to detect least mean squares differences between the obtained image and the known images. The image obtained by camera 106 is “correlated” against these known images, e.g. by finding at least mean squares differences between the image, and each of the known images. The system can properly deduce that its location is near the closest image.

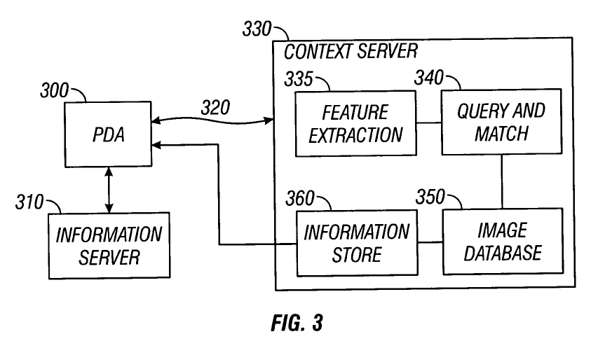

After detecting the image and position information, the environmental context is determined at 210. The environmental context postulates which of the objects within the view of the camera are most being viewed by the user. This is done using the hardware setup of FIG. 3.

FIG. 3 shows the basic hand-held assembly 300 including its image analysis capabilities. Hand-held 300 is connected via data link 320 to a context server 330. As described above, the context server 330 may in fact be implemented within the hand-held 300 itself, depending on the processing power of the hand-held.

The context server includes a feature extraction module 335. This module may operate as described above to mathematically analyze the image to obtain candidate features from the image based on stored information sets. For example, this may analyze the edges, frames, specified lighting effects, plaques, or other image parts that might indicate a salient part within the field of view.

The query and match database selects among the features to form a list of candidate image features, and the output forms queries used for the image database. From this, the object looked at is hypothesized, at 220.

Query and match module 345 compares the objects, subareas and environments. The results are used to query an image database 350. The query and match module may carry out different kinds of matching of the features. An object match may indicate that an entire object has been found in the image database as described herein. A solid area match may indicate that only one part of the image has been found within the database. An environmental match may indicate that the area being looked at matches the specific known environment within the image database.

The image database 350 has images of artifacts and surroundings in the locale. The database may include multiple image sets taken at various lighting conditions and different angles to aid in the recognition. In this way, the image database can identify multiple different items in multiple different lighting and observation conditions.

The output of the image database corresponds to the item that is expected to the most likely to be the item being looked at.

The feature extraction hence finds areas within the image that are expected to be salient.

Each of the hypothesized images are associated with sources of information in information store 360. The system includes information relating to each object that can be viewed. As described above, that information may be an address or other indication of local information stored within the PDA 300. For example, when the context server indicates that the user is viewing a painting P-1 shown as 140 in FIG. 1, the system may return either an address to information that is already stored within PDA 100 about painting P-1, or the actual information (rather than the address) about the painting itself. This information may then be displayed on the local handheld.

This system automatically provides information about the object that the user is viewing. For example, in a museum context, the system may returning information about a painting or other art object being viewed. If the user is viewing a floor map, the system may return map information. Analogously, in a theme park environment, when the user views a park map, the system may determine that the user is looking at a park map, and return additional information to the handheld about layout of the theme park. When the user stops outside an attraction within the theme park, again, the system may recognize that specific attraction (as one of the artifacts) and return information about the attraction. The same technique may be used in other areas; as long as the area being viewed is known, the system may return information that is sensitive to the area and specific item being viewed.

In another embodiment, an information server 310 may provide additional information as part of the information link. The information server 360 accepts requests for more conventional information (e.g. text descriptions) and returns information of a similar type to that described above.

Other embodiments are contemplated.

What is claimed is:

1. A computer system comprising:
an image acquiring device which obtains information indicative of an image of a scene, and wherein said image includes an artifact within the scene; and
a processor, which processes said information to determine likely artifact information within said scene, and provides artifact-sensitive information indicative of said artifact within said scene.

2. A system as in claim 1, wherein said image acquiring device includes a camera.

3. A system as in claim 1, further comprising a handheld computer, associated with said image acquiring device.

4. A system as in claim 3, wherein said processor is also associated with said handheld computer.

5. A system as in claim 3, further comprising a network element, associated with said handheld computer, and operating to send said information over a network to a remote location.

6. A system as in claim 5, wherein said network element comprises a wireless network element.

7. A system as in claim 1, wherein said artifact information includes an item of art.

8. A system as in claim 1, wherein said artifact information includes area information within a constrained area.

9. A system as in claim 1, wherein said artifact sensitive information comprises an address of locally stored information.

10. A system as in claim 5, wherein said network element connects to a remote processor, and wherein said artifact sensitive information comprises information from a remote source which describes said artifact.

11. A system as in claim 3, further comprising a position detecting part, which detects a position of said handheld computer, and wherein said processor is also responsive to said position.

12. A system as in claim 11, wherein said position detecting part is a global positioning satellite (GPS) part.

13. A system as in claim 3, wherein said processor also processes said information to determine a likely position of said handheld computer.

14. A system as in claim 1, wherein said processor determines features of interest within said scene.

15. A system, comprising:
a handheld computer including a processor, an image acquiring device which obtains an image of a scene being viewed, and a network part, said handheld computer coupling information indicative of said image to said network part, and receiving information indicative of specific parts within said image from said network part.

16. A system as in claim 15, further comprising a network processor, which processes said image to determine specific artifacts therein based on features of interest, and returns information which is specific to said specific artifacts.

17. A system as in claim 15, wherein said network part includes a wireless network part.

18. A system as in claim 15, wherein said processor operates to determine candidate features within said image.

19. A system as in claim 18, wherein said candidate features include one of edges, frames, or specified lighting effects.

20. A system as in claim 15, wherein said image acquiring device includes a camera.

21. A system as in claim 15, further comprising a location determining device which provides information indicative of location of said network part.

22. A system as in claim 17, wherein said network part is one of bluetooth, or 802.11 wireless network protocol.

23. A system as in claim 15, wherein said handheld computer is a personal digital assistant (PDA).

24. A system as in claim 15, wherein said handheld computer is a cellular telephone.

25. A method, comprising:
obtaining an image of an area around a user;
processing said image to determine salient features within said image of a specified type, which relate to a specified object within the image;
determining a most likely object within the image to represent an object of interest; and
returning information about said most likely object to the user.

26. A method as in claim 25, wherein said returning comprises returning an address of additional information about said most likely object.

27. A method as in claim 25, wherein said returning comprises returning actual information about said likely object.

28. A method as in claim 25, further comprising displaying said information about said most likely object.

29. A method as in claim 25, wherein said obtaining comprises obtaining an image using a handheld computer.

30. A method, comprising:
forming a database including a plurality of images of objects;
associating information with each of said plurality of objects;
automatically determining, using an image acquiring element, one of said objects in said database being viewed by said user; and
determining information associated with said objects in said database.

31. A method as in claim 30, wherein said forming comprises obtaining multiple images for at least a plurality of the objects, and said multiple images representing the objects as seen in different conditions.

32. A method as in claim 31, wherein said different conditions comprise different lighting.

33. A method as in claim 31, wherein said different conditions comprise different angles.

34. A method as in claim 31, further comprising obtaining an image in a handheld computer, and using said image to access said database.

35. A method as in claim 34, wherein said using comprises extracting parts of the image which are likely to be relevant, and accessing said image database with said parts.

36. A method as in claim 34, further comprising determining a location of said handheld computer.

37. A method as in claim 36, wherein said determining comprises automatically determining said location using a global positioning satellite system.

38. A method as in claim 36, wherein said determining comprises a determining said location using said image.

39. An article comprising:
a machine-readable medium which stores machine-executable instructions, the instructions causing a machine to:
acquire an electronic representation of an image indicative of the scene with an artifact within the scene; and
process the electronic representation to provide information indicative of the artifact.

40. An article as in claim 39, wherein said process comprises determining likely candidate features within the electronic representation, and using said features to access a database of known artifacts.

41. An article as in claim 40, further comprising accessing said database to determine said information indicative of the identified artifact.
